(19) United States
(12) Patent Application Publication
(10) Pub. No.: US 2008/0286582 A1
(43) Pub. Date: Nov. 20, 2008

(54) Surge absorbing material with dual functions

(75) Inventors: Yu-Wen Tan, Taipei (TW); Jie-An Zhu, Shanghai (CN); Li-Yun Zhang, Shanghai (CN)

Correspondence Address: BACON & THOMAS, PLLC, 625 SLATERS LANE, FOURTH FLOOR, ALEXANDRIA, VA, 22314-1176, US

(73) Assignee: LEADER WELL TECHNOLOGY CO., LTD., Guishan Shiang (TW)

(21) Appl. No.: 11/798,967

(22) Filed: May 18, 2007

(51) Int. Cl. B32B 17/06

(52) U.S. Cl. 428/429; 428/426; 428/433; 428/434

(57) ABSTRACT

A surge absorbing material with dual functions has one of the characteristics among capacitance, inductance, voltage suppressor and thermistor in addition to surge absorbing characteristic, which microstructural compositions include a glass substrate with high resistance and three kinds of low-resistance conductive or semiconductive particles in micron, submicron and nanometer size uniformly distributed in the glass substrate to provide with good surge absorbing characteristic.

### BACKGROUND OF THE INVENTION

1. Field of the Invention

The present invention relates to a surge absorbing material, and more particularly, to a surge absorbing material with dual functions having one of the characteristics among capacitance, inductance, voltage suppressor and thermistor in addition to surge absorbing characteristic.

2. Description of the Related Art

Surge or electrical overstress produced by a lightning strike, switching operation or damage of other component may disturb or damage electronic components or other sensitive electric equipment. Therefore, surge absorbers (or called varistors) with good surge absorbing capability are widely used as components for providing protection against electrical overstress or surge of electronic components, electronic circuits or electronic equipment.

Moreover, it is a popular trend to combine two components of different functions as a single structure by a laminating process. For example, inductance and capacitance are combined as a single SMD-type (surface mounting device) component to become an inductance-capacitance filter (LC filter) with filtering function; or, resistance and capacitance are combined as a single SMD-type component to become a resistance-capacitance filter (RC filter) with filtering function.

However, when two components of different functions are combined as a single structure by a laminating process, a residual stress is easily occurred between the two components because sintering temperatures and shrinkage rates of the two components are different, and then there are problems of separation and ineffectiveness occurred after the two components of different functions are sintered together into a single structure.

For solving the problems mentioned above, some prior arts disclose a low-temperature glass disposed between a surge absorber and a ceramic condenser to enhance the connection of the two materials. Some prior arts disclose a varistor layer mainly composed of Zinc oxide with different additional elements to provide the material with functions of surge absorber and inductor, and then the two layers are combined by a laminating process and sintered together.

In addition, in some researches, for improving the problem of bad electrical characteristics due to mutual diffusivity during the sintering process of two materials, insulating layers with varying contents are disposed between two components.

However, although the methods mentioned above can produce components of multiple functions, the processes are relatively complicated. For instance, glass or an insulating layer with varying contents needs to be added into two materials of components to provide the components with electrical characteristics. Moreover, in such processes, two components requiring different sintering atmospheres cannot be sintered together, and thus the product cannot have good electrical characteristics.

### SUMMARY OF THE INVENTION

One object of the present invention is to provide a method for producing a surge absorbing material with dual functions. By a first-order, second-order or third-order dispersing method, conductive or semiconductive particles of micron, submicron and nanometer size are wrapped in a suitable material of a glass phase, and then sintered to have good surge absorbing characteristic. Furthermore, when the material of a glass phase is selected from materials with one of the characteristics among capacitance, inductance, voltage suppressor and thermistor, the surge absorbing material becomes a material with dual functions having one of the characteristics among capacitance, inductance, voltage suppressor and thermistor in addition to surge absorbing characteristic, and the problem of separation and ineffectiveness occurred when two materials of different characteristics are sintered together into a single structure can be solved.

The other object of the present invention is to provide a surge absorbing material with dual functions, which material compositions include a glass substrate with high resistance and low-resistance conductive or semiconductive particles including micron, submicron and nanometer size distributed in the glass substrate, particularly, conductive or semiconductive particles of submicron size are uniformly distributed in conductive or semiconductive particles of micron size, and conductive or semiconductive particles of nanometer size are uniformly distributed in conductive or semiconductive particles of submicron size.

When such surge absorbing material of the present invention is used in producing laminated components, the problem of cofiring different materials as a single structure is not necessarily considered any more and the laminating process is relatively simple and easy.

### BRIEF DESCRIPTION OF THE DRAWINGS

FIG. 1 is a schematic view showing microstructural compositions of a surge absorbing material according to one preferred embodiment of the present invention.

FIG. 2 is an enlarged view of the A area in FIG. 1.

FIG. 3 is an enlarged view of the B area in FIG. 2.

FIG. 4 is a schematic view showing a laminated chip surge absorber.

### DETAILED DESCRIPTION OF THE PREFERRED EMBODIMENT

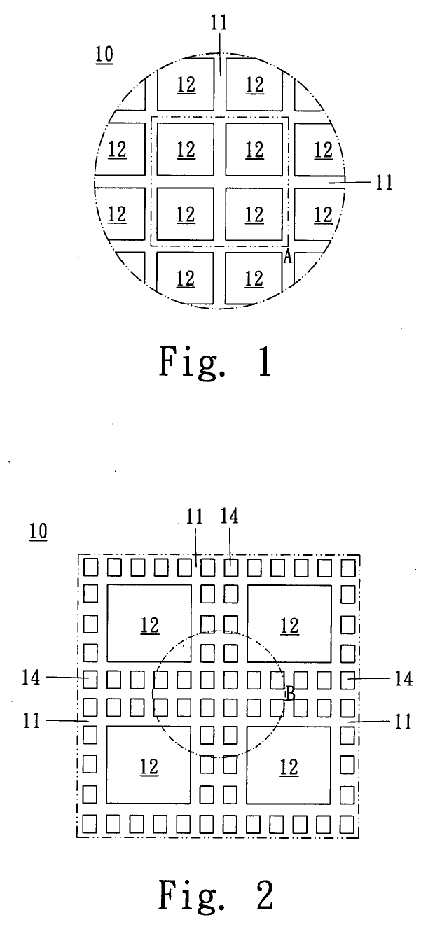

As shown from FIG. 1 to FIG. 3, the microstructural compositions of a surge absorbing material 10 of the present invention include a glass substrate 11 with high resistance and low-resistance micron conductive or semiconductive particles 12, submicron conductive or semiconductive particles 14 and nanometer conductive or semiconductive particles 16 uniformly distributed in the glass substrate 11. The particle diameter of micron conductive or semiconductive particles 12 is larger than 0.1 μm, the particle diameter of submicron conductive or semiconductive particles 14 is between 0.1 to 0.01 μm, and the nanometer particle diameter of conductive or semiconductive particles 16 is smaller than 0.01 μm. The conductive particle is selected from one or more of Pt, Pd, W, Au, Al, Ag, Ni, Cu, Fe and alloy thereof.

The semiconductive particle is selected from one of ZnO, TiO₂, SnO₂, Si, Ge, SiC, Si—Ge alloy, InSb, GaAs, InP, GaP, ZnS, ZnSe, ZnTe, SrTiO₃ and BaTiO₃.

As shown in FIG. 1, the surge absorbing material 10 of the present invention includes glass substrate 11 of 3˜60 wt % and micron conductive or semiconductive particles 12 with particle diameter more than 0.1 μm of 40˜97 wt %, based on the total weight of the surge absorbing material 10.

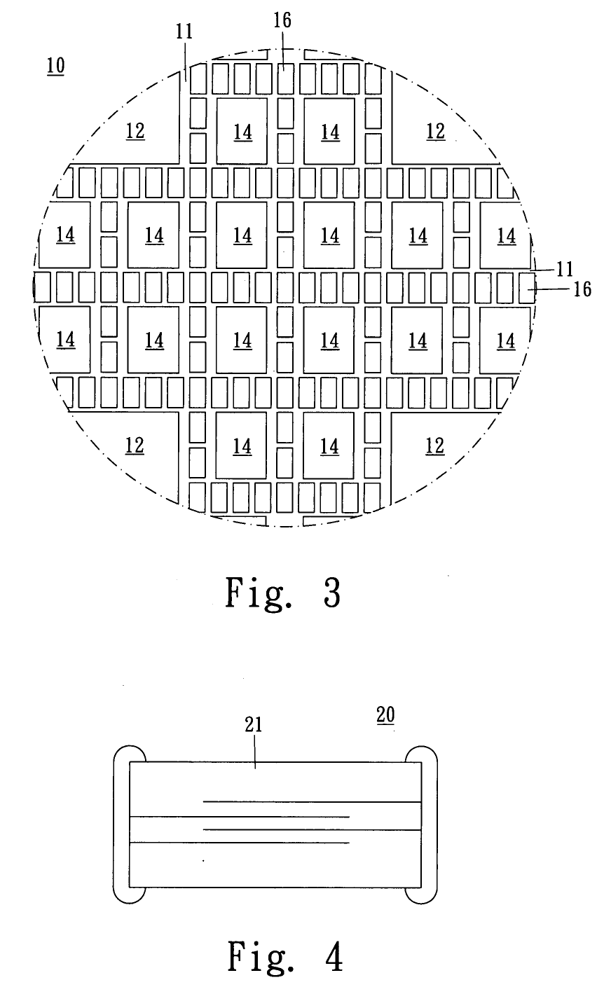

In addition, as shown in FIG. 2, in the microstructural compositions of the surge absorbing material 10, second-order dispersed submicron conductive or semiconductive particles 14 are uniformly distributed in first-order dispersed micron conductive or semiconductive particles 12; as shown in FIG. 3, third-order dispersed nanometer conductive or semiconductive particles 16 are uniformly distributed in second-order dispersed submicron conductive or semiconductive particles 14. Therefore, the microstructural compositions of a surge absorbing material 10 include three kinds of low-resistance conductive or semiconductive particles 12, 14 and 16 with different particle diameters uniformly dispersed in the glass substrate 11, and such compositions provide the surge absorbing material 10 with the characteristic of surge absorber.

As shown in FIG. 4, when a ceramic layer 21 of a laminated chip surge absorber 20 is made by the surge absorbing material 10 according to the present invention, because the ceramic layer 21 is made of heat-resisting glass material and there are micron conductive or semiconductive particles 12 and submicron conductive or semiconductive particles 14 distributed in the microstructural compositions of the ceramic layer 21, the laminated chip surge absorber 20 is endurable to heat generated from electrostatic shocks and surge overstresses.

Most of all, second-order dispersed submicron conductive or semiconductive particles 14 and third-order dispersed nanometer conductive or semiconductive particles 16 are further contained in the ceramic layer 21, and the particle distances of nanometer conductive or semiconductive particles 16 are so small that a tunnel effect occurs when an abnormal electrical overstress is applied. Thus, laminated chip surge absorber 20 has good electrical overstress suppressing capability and electrostatic shock resistance, as well as a good lifespan.

In sum, the surge absorbing material 10 has one of the characteristics among capacitance, inductance, voltage suppressor and thermistor in addition to surge absorbing characteristic by choosing the glass substrate 11 from one of a capacitance glass state component, an inductance glass state component, a voltage suppressor glass state component and a thermistor glass state component. In other words, the surge absorbing material 10 is a material with dual functions.

A method for producing the surge absorbing material 10 according to the preferred embodiment of the present invention includes following steps:

(1) Selecting suitable glass phase compositions to provide the glass substrate 11 of the surge absorbing material 10 with one of the characteristics among capacitance, inductance, voltage suppressor and thermistor, and using a sol-gel process to produce a solution of the glass phase composition.

When the glass substrate 11 is the capacitance glass state composition, the glass substrate 11 can be selected from silicate glass, aluminosilicate glass, borate glass and phosphate glass with general capacitance characteristics and BaTiO₃, SrTiO₃, CaTiO₃ and TiO₂ with high dielectric constants.

When the glass substrate 11 is the inductance glass state composition, the glass substrate 11 can be selected from a series of Ni—Zn or Ni—Cu—Zn inductance material of general inductance characteristics, or a LTCC material with high frequency inductance characteristics.

When the glass substrate 11 is the voltage suppressor glass state composition, the glass substrate 11 can be an electrical overstress suppressing material such as BaTiO₃, PZT and PLZT.

When the glass substrate 11 is the thermistor glass state composition, the glass substrate 11 can be a thermistor material with general thermistor characteristics such as a Mn—Ni or Mn—Co—Ni system with NTC characteristic or a V—P—Fe system with CTR characteristic.

(2) Dispersing metal or semiconductive particles of nanometer size uniformly into the glass solution in step (1).

The nanometer particles have particle diameters smaller than 0.01 μm, and can be metal conductive particles comprising Pt, Pd, Au, Ag, Ni, Cu and so on, or semiconductive particles comprising SiC, ZnO, TiO₂, SnO₂, SrTiO₃, BaTiO₃ and so on.

(3) Dispersing conductive or semiconductive particles of submicron size uniformly into the solution having metal or semiconductive particles of nanometer dispersed therein in step (2).

(4) Dispersing conductive or semiconductive particles of micron size uniformly into the solution having submicron and nanometer metal or semiconductive particles dispersed therein in step (3).

(5) Dying and calcining the solution after step (4) at a suitable temperature (lower than 1000° C.) and then milling it into a composite material to become the surge absorbing material 10 according to the preferred embodiment of the present invention. The surge absorbing material 10 of the present invention has one of the characteristics among capacitance, inductance, voltage suppressor and thermistor in addition to surge absorbing characteristic. Thus, when producing various components from the surge absorbing material 10, which characteristic between capacitance, inductance, voltage suppressor and thermistor in addition to surge absorbing characteristic is to be provided on the component should be considered.

For instance, when the surge absorbing material 10 is a material having inductance characteristic in addition to surge absorbing characteristic, the surge absorbing material 10 may be produced as a surge absorber or a filtering component with both electromagnetic wave disturbance (EMI) preventing capability and electrostatic discharge (ESD) preventing capability. Moreover, the material of such filtering component has good surge and electrostatic absorbing capability, and the material retains original characteristics after multiple times of surge and electrostatic shocks.

What is claimed is:

1. A surge absorbing material comprising a glass substrate with high resistance and low-resistance conductive or semiconductive particles including micron, submicron and nanometer size distributed in the glass substrate, wherein the surge absorbing material based on the total weight includes the glass substrate of 3˜60 wt % and conductive or semiconductive particles with particle diameter more than 0.1 μm of 40˜97 wt %, and wherein conductive or semiconductive particles of submicron size are distributed in conductive or semiconductive particles of micron size, and conductive or semiconductive particles of nanometer size are distributed in conductive or semiconductive particles of submicron size.

2. The surge absorbing material as defined in claim 1, wherein the particle diameter of micron conductive or semiconductive particles is larger than 0.1 μm, the particle diameter of submicron conductive or semiconductive particles is between 0.1 to 0.01 μm, and the particle diameter of nanometer conductive or semiconductive particles is smaller than 0.01 μm.

3. The surge absorbing material as defined in claim 2, wherein the glass substrate is selected from the group consisting of a capacitance glass state component, an inductance glass state component, a voltage suppressor glass state component and a thermistor glass state component.

4. The surge absorbing material as defined in claim 3, wherein the capacitance glass state component comprises silicate glass, aluminosilicate glass, borate glass and phosphate glass with capacitance characteristics and BaTiO₃, SrTiO₃, CaTiO₃ and TiO₂ with high dielectric constants.

5. The surge absorbing material as defined in claim 3, wherein the inductance glass state component comprises a series of Ni—Zn, Ni—Cu—Zn inductance material of inductance characteristics, and a LTCC material with high frequency inductance characteristics.

6. The surge absorbing material as defined in claim 3, wherein the voltage suppressor glass state component comprises BaTiO₃, PZT and PLZT with electrical overstress suppressing characteristics.

7. The surge absorbing material as defined in claim 3, wherein the thermistor glass state component comprises a Mn—Ni, a Mn—Co—Ni system with NTC characteristic and a V—P—Fe system with CTR characteristic.

8. The surge absorbing material as defined in claim 3, wherein the conductive particle is selected from the group consisting of one or more of Pt, Pd, W, Au, Al, Ag, Ni, Cu and alloy thereof.

9. The surge absorbing material as defined in claim 3, wherein the semiconductive particle is selected from the group consisting of one or more of ZnO, TiO₂, SnO₂, Si, Ge, SiC, Si—Ge alloy, InSb, GaAs, InP, GaP, ZnS, ZnSe, ZnTe, SrTiO₃ and BaTiO₃.
